(19) United States
(12) Patent Application Publication
(10) Pub. No.: US 2021/0233004 A1
(43) Pub. Date: Jul. 29, 2021

(54) Regression Analysis to Quantify Potential Optimizations

(71) Applicant: International Business Machines Corporation, Armonk, NY (US)

(72) Inventors: Yuan ZHANG, Beijing (CN); David KOEPKE, Evergreen Park, IL (US); Bibo HAO, Beijing (CN); Jing MEI, Beijing (CN); Rachna GUPTA, Troy, MI (US); Rajashree RAO JOSHI, West Bloomfield, MI (US)

(21) Appl. No.: 16/773,764

(22) Filed: Jan. 27, 2020

(51) Int. Cl. G06Q 10/06; G06F 17/18; G06F 17/16

(52) U.S. Cl. CPC G06Q 10/06315; G06F 17/16; G06F 17/18

(57) ABSTRACT

Techniques for regression analysis of optimization potential are provided. An actionable set of data elements is identified in operational data, where the operational data comprises a plurality of data elements. A regression model is generated based on the operational data, where the regression model defines a contribution weight for at least a first data element of the actionable set of data elements. A first expected value is determined for the first data element based on industry data. A potential optimization for the first data element is then quantified, based at least in part on the first expected value and the contribution weight of the first data element.

### BACKGROUND

The present disclosure relates to organizational optimizations, and more specifically, to utilizing regression analysis to quantify optimizations in operational structures.

Organizations and institutions, ranging from small businesses, to hospitals, and even to multi-national corporations, often have significantly complex structures and operations. A huge variety and number of factors and metrics define the operations of the entity, which significantly obfuscates opportunities for improvements and optimizations the entity can implement. This can hinder advancement, allowing unnecessary waste to exist hidden in the system, while further preventing introduction of significant improvements.

### SUMMARY

According to one embodiment of the present disclosure, a method is provided. The method includes identifying an actionable set of data elements in operational data, wherein the operational data comprises a plurality of data elements, and generating a regression model based on the operational data, wherein the regression model defines a contribution weight for at least a first data element of the actionable set of data elements. The method further includes determining a first expected value for the first data element based on industry data. Additionally, the method includes quantifying a potential optimization for the first data element, based at least in part on the first expected value and the contribution weight of the first data element.

According to a second embodiment of the present disclosure, a computer program product is provided. The compute program product comprises one or more computer-readable storage media collectively containing computer-readable program code that, when executed by operation of one or more computer processors, performs an operation. The operation includes identifying an actionable set of data elements in operational data, wherein the operational data comprises a plurality of data elements, and generating a regression model based on the operational data, wherein the regression model defines a contribution weight for at least a first data element of the actionable set of data elements. The operation further includes determining a first expected value for the first data element based on industry data. Additionally, the operation includes quantifying a potential optimization for the first data element, based at least in part on the first expected value and the contribution weight of the first data element.

According to a third embodiment of the present disclosure, a system is provided. The system includes one or more computer processors, and one or more memories collectively containing one or more programs which, when executed by the one or more computer processors, performs an operation. The operation includes identifying an actionable set of data elements in operational data, wherein the operational data comprises a plurality of data elements, and generating a regression model based on the operational data, wherein the regression model defines a contribution weight for at least a first data element of the actionable set of data elements. The operation further includes determining a first expected value for the first data element based on industry data. Additionally, the operation includes quantifying a potential optimization for the first data element, based at least in part on the first expected value and the contribution weight of the first data element.

### BRIEF DESCRIPTION OF THE SEVERAL VIEWS OF THE DRAWINGS

FIG. 1 depicts a workflow for evaluating operational data to visualize potential optimizations, according to one embodiment disclosed herein.

FIG. 2 is a flow diagram illustrating a method for evaluating data elements and performing regression analysis in order to identify operational optimizations, according to one embodiment disclosed herein.

FIG. 3 is a flow diagram illustrating a method for quantifying and summarizing optimization opportunities, according to one embodiment disclosed herein.

FIG. 4 depicts a graphical user interface (GUI) used to visualize potential optimizations in a hierarchical organization, according to one embodiment disclosed herein.

FIG. 5 is a flow diagram illustrating a method to perform regression analysis on data elements to quantify optimizations, according to one embodiment disclosed herein.

FIG. 6 is a block diagram depicting an optimization system configured to apply regression analysis to quantify optimizations, according to one embodiment disclosed herein.

### DETAILED DESCRIPTION

Embodiments of the present disclosure apply regression analysis to operational data in order to identify quantified, attributable, and actionable optimizations in organizations. In one embodiment, given operational data for one or more organizations, the system can build one or more regression models for given optimization targets for any number of units/departments, and use these models to determine a contribution ratio or weight for each data element. As used herein, a data element is a unit of the operational data/organizational structure, and includes a discrete value or metric indicating how the organization functions. For example, a data element may correspond to the wage index of the area. Other examples include, without limitation, the number and/or percentage of full time employees (as opposed to part time), the skill mix of employees (e.g., by degree or title), overtime hours worked, hourly rates, the number and/or percentage of each type of employee, the number and/or cost of consumables used by the organization, and the like.

These data elements can further be specific to individual units or levels in a hierarchical structure, in some embodiments. For example, the operational data may include any number of discrete data elements for each team in a department, where the elements indicate the number of employees of a given type that are associated with the corresponding team. In embodiments, the data elements can generally represent any metric relevant to the corresponding organization. Given a set of data elements, embodiments of the present disclosure utilize regression analysis (such as a generalized estimating equation) to determine the contribution ratio or weight of each element relative to the other elements in the organization, in terms of the impact it makes (e.g., the costs it introduces or reduces).

In one embodiment, the system can utilize these regression models to quantify optimization opportunities for each data element (e.g., cost reduction opportunities) based on the corresponding contribution ratio, the current value of the metric, and the expected value. In some embodiments, the system determines the expected value for a given data element based on operational data collected from other entities or organizations in the industry and/or area. For example, the system may determine the median or mean number of employees in a given department (e.g., the number of registered nurses in an acute care ward) among a number of operations in the region (e.g., other hospitals). In at least one embodiment, the system utilizes other techniques such as matrix factorization (e.g., singular value decomposition) of the industry data to determine expected values for a given data element.

In at least one embodiment, prior to computing these potential optimizations, the system first determines the actionability of each element. The system can then proceed to evaluate optimization opportunities only for actionable elements, in order to reduce computational resource consumption. As used herein, a data element is actionable if it can be controlled or changed by the organization. This can include things that physically can be changed. In some embodiments, the actionabiilty determination further considers things that can be legally changed (within the relevant laws, regulations, and/or company policies). For example, the number of consumables used by a department can be physically modified, but the wage index of the area cannot be. As an example of a legal restriction, the ratio of managers to employees may be legally changeable, although there may be a legal or operational restriction on the minimum and/or maximum values.

In one embodiment, the actionability of a given data element is determined by a subject matter expert. In another embodiment, the system utilizes data mining of a variety of information sources for the industry in order to determine whether each data element is actionable and can be changed. For example, the system may evaluate information to determine whether a data element has previously been discussed or referred to as modifiable. Similarly, in some embodiments, the system analyzes the underlying metric(s) over time and/or across different organizations in order to determine whether the corresponding elements are actionable. For example, if the metric has changed over time within the organization, and/or different organizations have different values for the metric, the system may infer that the metric is actionable.

In an embodiment, once opportunities and/or impacts have been determined for each data element (or for each actionable data element), the system can aggregate the quantified opportunities based on the organizational structure. For example, given a hierarchical organization, the system may define the cost reduction opportunities at a given level of the hierarchy as the sum of the underlying (positive) opportunities. In one such embodiment, when aggregating the quantified values, the system can ignore nonactionable items, as well as items that would lead to cost increases. In some embodiments, the system further facilitates visualization of these opportunities, as discussed in more detail below.

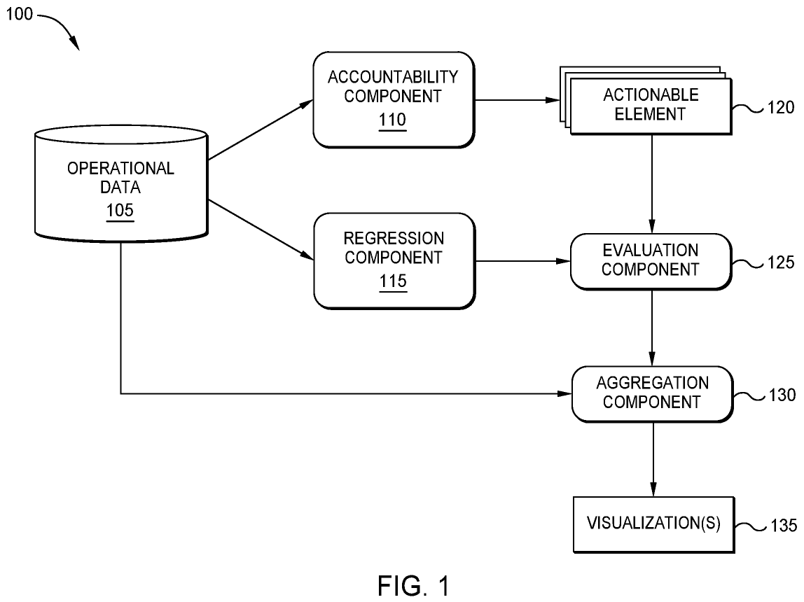

FIG. 1 depicts a workflow 100 for evaluating operational data to visualize potential optimizations, according to one embodiment disclosed herein. In one embodiment, the workflow 100 is performed by an optimization system including any number of components and modules. The optimization system may be implemented using hardware, software, or a combination of hardware and software. In the illustrated workflow 100, Operational Data 105 is provided to an Actionability Component 110 and a Regression Component 115. In an embodiment, the Operational Data 105 can include any number of metrics and values for any number of organizational entities. As discussed above, the Operational Data 105 may include a set of data elements for each organization, where each data element includes granular data about one or more specific metrics or aspects of the organization. In some embodiments, the Operational Data 105 includes data for a number of entities (e.g., multiple hospitals) in order to facilitate the analysis.

In the illustrated workflow 100, the Actionability Component 110 evaluates the Operational Data 105 to identify and label elements that are actionable. In one embodiment, as discussed above, this includes performing data mining and analysis to determine, for each data element, whether it can be changed. In some embodiments, this can be based on evaluating relevant literature using one or more natural language processing (NLP) techniques. In another embodiment, the Actionability Component 110 determines actionability based on whether the value of the data element has changed over time within the organization, in a way that is not explained by other information (such as a predictable trend in wage index, or a new regulation raising minimum wage). In still another embodiment, the Actionability Component 110 determines actionability based on whether the value differs between organizations (e.g., whether the metric for a first organization differs from the same metric in a second organization). In some embodiments, the Actionability Component 110 determines actionability based at least in part on analysis of the decomposition of elements. For example, if an element is comprised of two or more sub-elements, the Actionability Component 110 can determine that the element is not actionable if all of the sub-elements are not actionable.

In at least one embodiment, when evaluating the Operational Data 105, the Actionability Component 110 considers data related to other organizations only if it is relevant to the entity being analyzed. This can include commercially relevant (e.g., within the same industry), regionally relevant (e.g., within a predefined region or distance), temporally relevant (e.g., the data is current/accurate, within a predefined period of time), and the like. As illustrated, based on this analysis, the Actionability Component 110 labels a set of Actionable Elements 120. These Actionable Elements 120 are those that correspond to metrics/data which can be changed, such as by restructuring the organization, adjusting policies and practices, and the like.

In the illustrated embodiment, the Regression Component 115 similarly evaluates the Operational Data 105. In one embodiment, the Regression Component 115 evaluates the Operational Data 105 for each organization independently, in order to determine the contribution ratios specific to the given organization. In another embodiment, the Regression Component 115 collectively performs the regression analysis, in order to determine an industry-wide contribution ratio for each metric. In an embodiment, the Regression Component 115 performs the regression analysis using the values specified by each data element as input, using one or more target outputs specified by the user. For example, the user may specify to determine the contribution of each element with respect to labor costs, materials costs, and the like.

Stated differently, in one embodiment, the Regression Component 115 takes one or more user defined targets and a set of relevant data elements as input, and perform regression analysis on this data. In an embodiment, the relevant data elements are chosen based on one or more feature selection techniques. In another embodiment, the relevant data elements are predefined based on the user's query target. For example, if the user specifies to explore targets such as labor costs and materials costs, the feature selection process can generate or identify a set of relevant data elements, and the contribution of each element with respect to each target is then determined by the Regression Component 115.

In one embodiment, the output of the Regression Component 115 is a regression model that specifies the contribution ratio of each data element (also referred to as a contribution weight, a coefficient, and the like). The contribution ratio indicates how the indicated target (e.g., labor costs) will change, as a function of changing the metric of the data element. For example, suppose a data element corresponding to the skill mix of a department (e.g., the percentage of employees in the department with a master's education) has a coefficient of −2.5. In an embodiment, this coefficient indicates that if the metric is increased by one unit, the labor costs will be reduced by 2.5 units. In the illustrated embodiment, the Regression Component 115 evaluates the Operational Data 105 including both actionable and non-actionable elements. In some embodiments, however, the Regression 115 considers only the Actionable Elements 120 when performing the regression.

As illustrated in the depicted workflow 100, an Evaluation Component 125 receives the indications of Actionable Elements 120, as well as the results of the regression (e.g., a set of contribution weights for each element). The Evaluation Component 125 can then utilize this data to identify and quantify potential optimizations (e.g., cost-reduction opportunities). In one embodiment, the Evaluation Component 125 does so by determining an expected value for each data element (or for each Actionable Element 120). To do so, the Evaluation Component 125 may evaluate the Operational Data 105 for one or more entities in the industry. For example, the Evaluation Component 125 may determine the mean and/or median values for each metric (or only for the Actionable Elements 120). In other embodiments, the Evaluation Component 125 can utilize matrix factorization to determine expected values for each element.

The Evaluation Component 125 can then determine the possible improvements for each data element based on the actual and expected values for the metric, the regression coefficient of the metric, and the actionability of the metric. In at least one embodiment, the quantified optimization f(xᵢ) for a given data element i with a value of xᵢ is given by Equation 1 below, where aᵢ is the actionability of the data element, wᵢ is the contribution weight or coefficient if the element, and E(xᵢ) is the expected value for the metric.

f(xᵢ)=aᵢwᵢ(xᵢ−E(xᵢ)) Equation 1

In one embodiment, the actionability of a data element is a binary value (e.g., zero or one). In another embodiment, the actionability can be a continuous value between zero and one, where higher values indicate that the metric is more likely to be actionable and/or is more-easily changed, and lower values indicate that the metric is less likely to be actionable and/or less-easily changed. As an example, suppose a first data element e corresponds to the average number of overtime hours worked per week by a particular type of employee in a particular department. Suppose further the value for this element xₑ is 3.7 for a first organization, while the expected value E(xₑ) (e.g., the industry mean) is 1.3. Additionally suppose that the Actionability Component 110 has determined that this element is entirely actionable (e.g., such that aₑ=1), and the Regression Component 115 has assigned a contribution weight wₑ of 2.7.

Using Equation 1, therefore, the Evaluation Component 125 can determine that the quantifiable optimization opportunity F(xₑ) for the element e is 6.48. That is, reducing the value by one unit (e.g., by an average of one hour per week per employee) will reduce costs by 6.48 units. In some embodiments, this information is returned (e.g., to a user). In at least one embodiment, the system further identifies recommendations to achieve these optimizations.

For example, for the above element, the system may suggest hiring additional staff to reduce average overtime hours.

In one embodiment, the Evaluation Component 125 quantifies optimization opportunities for each Actionable Element 120. In some embodiments, the Evaluation Component 125 further determines opportunities for nonactionable elements. As illustrated, once the optimization opportunities have been identified and quantified, the workflow 100 continues to an Aggregation Component 130. The Aggregation Component 130 receives the quantified cost opportunities from the Evaluation Component 125, and aggregates the data based on the Operational Data 105. In one embodiment, this includes aggregating the optimization opportunities at each level of a hierarchical organization. For example, the Aggregation Component 130 can sum the positive opportunities within each department/team to determine the opportunities for the entire department, and then sum up the values for each department to determine optimizations available across the entire organization.

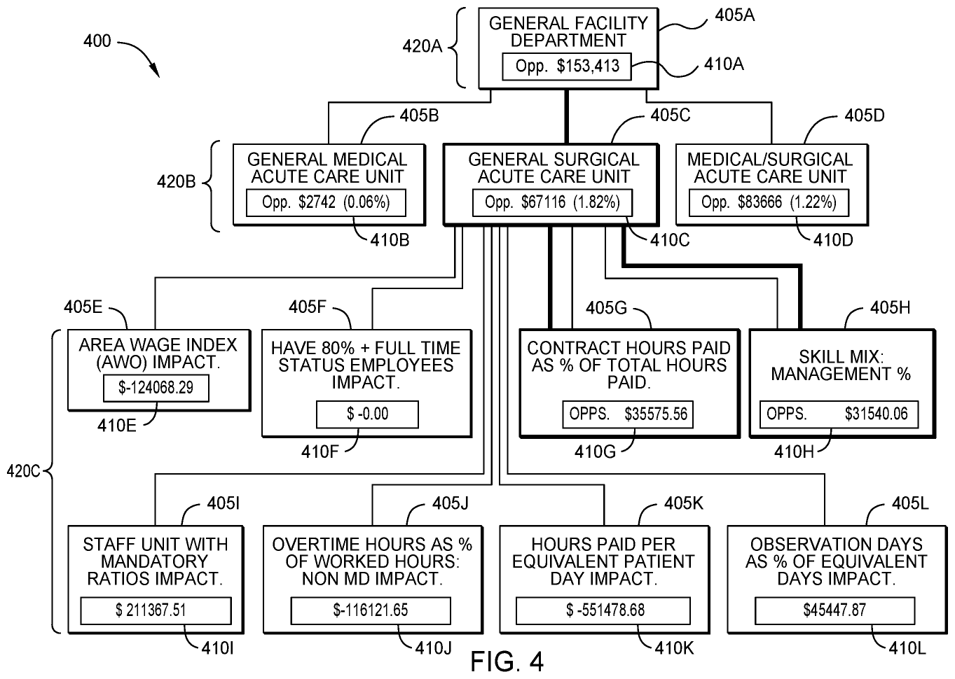

As illustrated, the data is then returned in the form of one or more Visualization(s) 135 (e.g., output on a GUI). These Visualizations 135 can include, for example, a visual depiction of the organizational structure and hierarchy, using a number of nodes representing each logical unit (e.g., a department, team, committee, and the like). In some embodiments, the individual data elements representing tangible metrics are further included, along with an opportunity and/or impact of each. An example of one such GUI is discussed in more detail below, with reference to FIG. 4.

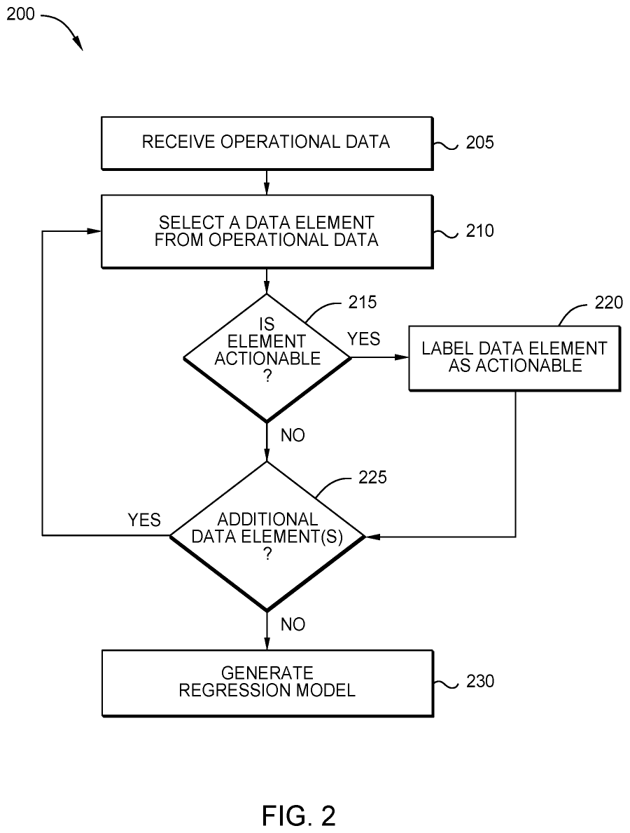

FIG. 2 is a flow diagram illustrating a method 200 for evaluating data elements and performing regression analysis in order to identify operational optimizations, according to one embodiment disclosed herein. The method 200 begins at block 205, where an optimization system receives operational data for one or more entities/organizations. As discussed above, in embodiments, the operational data include a set of data elements for one or more entities, where each data element specifies a unit of operational data for the entity, such as a value, metric, or other quantifiable measure relevant to the entity. This can include information related to any number of aspects for the company, including labor costs, material inventory and costs, real estate inventor and costs, investments, debts, holdings, and the like.

The method 200 then continues to block 210, where the optimization system selects one of the data elements included in the operational data. In at least one embodiment, the optimization system selects from a set of relevant/candidate data elements, as opposed to the entire set of raw data. That is, in one such embodiment, the optimization system first identifies a set of relevant elements (e.g., using feature selection techniques or using predefined associations between given targets and corresponding relevant elements). The method 200 then proceeds to block 215. At block 215, the optimization system determines whether the selected element is actionable. As discussed above, an element is generally considered to be actionable if it corresponds to an aspect of the entity that can be modified or changed. In some embodiments, an element is only actionable if it can be feasibly or plausibly changed. In at least one embodiment, the actionability of each element is a non-binary value indicating the probability that the element can be changed, and/or the degree of ease with which the element can be changed.

In one embodiment, determining whether the selected element is actionable includes requesting input from a user, such as a subject matter expert or consultant. In some embodiments, the optimization system evaluates literature (such as articles and papers related to the industry) to determine whether the element is actionable. In at least one embodiment, the optimization system evaluates the operational data to determine whether the element is actionable, such as by determining whether the value has changed over time, whether the value differs for different organizations, and the like.

If the optimization system determines that the selected element is actionable (to at least some extent), the method 200 continues to block 220, where the optimization system labels the element as actionable. In one embodiment, this is a binary classification. That is, if there is at least some probability that the item is actionable (e.g., above a predefined threshold), and/or the difficulty of changing the element is sufficiently low (e.g., below a predefined threshold), the optimization system simply labels it as actionable. In another embodiment, the actionability label includes an indication as to the degree of actionability, as discussed above. For example, the label may specify the likelihood that the element is actually changeable, the feasibility of changing it, and the like. The method 200 then continues to block 225.

Returning to block 215, if the optimization system determines that the selected element is not actionable, the method 200 proceeds to block 225. At block 225, the optimization system determines whether there is at least one additional data element that has not yet been evaluated. If so, the method 200 returns to block 210. Otherwise, the method 200 continues to block 230. At block 230, the optimization system generates one or more regression models for the data, as discussed above.

In an embodiment, the regression model involves using regression analysis to determine a contribution weight, factor, coefficient, ratio, or value for each data element, relative to a specified target such as costs. That is, the regression analysis is used to determine the contribution of each individual element to the overall cost. In some embodiments, the optimization system only considers actionable elements when performing the regression analysis. In one embodiment, the optimization system performs regression on a per-entity basis, such that the contribution ratio of a given element is specific to the operational data of the particular entity. In another embodiment, the optimization system performs regression on industry-wide data, to determine aggregate contribution coefficients.

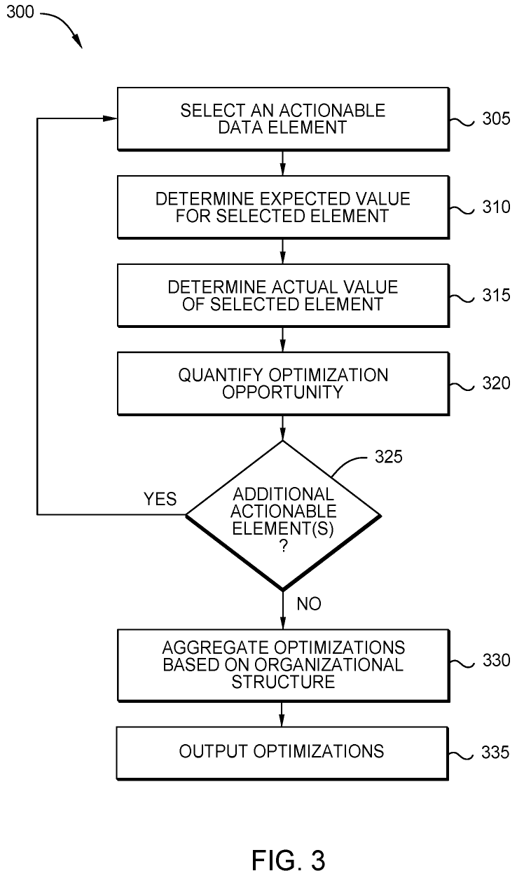

FIG. 3 is a flow diagram illustrating a method 300 for quantifying and summarizing optimization opportunities, according to one embodiment disclosed herein. In one embodiment, the method 300 is performed after the regression model(s) are built, and/or actionability of each data element has been determined. The method 300 begins at block 305, where an optimization system selects one of the identified actionable elements. At block 310, the optimization system determines the expected value for the selected element. In one embodiment, this includes determining the mean and/or median value of the corresponding metric, with respect to other relevant and comparable entities. For example, the optimization system may evaluate data for other companies that are within the region, of similar size, in the same or a related industry, and the like. In another embodiment, rather than using the mean and/or median of this data, the optimization system performs more complex analysis, such as singular value decomposition, to determine an expected value for the selected element.

The method 300 then continues to block 315, where the optimization system determines the actual value of the selected element, with respect to the organization that is being analyzed. For example, the data element may itself specify the value for the entity. Alternatively, the optimization system can retrieve the value for the selected metric/element from the operational data or other sources. The method 300 then continues to block 320, where the optimization system quantifies the optimization potential based on the expected value, actual value, actionability index, and/or contribution ratio of the selected element, as discussed above. In at least one embodiment, the optimization system does so using Equation 1, above.

At block 325, the optimization system then determines whether there is at least one additional actionable element that has not yet been evaluated for the entity. If so, the method 300 returns to block 305. Otherwise, the method 300 continues to block 330. At block 330, the optimization system aggregates the determined optimization opportunities based on the entity's organizational (hierarchical) structure. For example, the optimization system may determine the optimization potential at a given level by summing the cost saving opportunities at the lower nodes. Finally, at block 335, the optimization system outputs the determined optimization opportunities, along with the quantified value or cost.

FIG. 4 depicts a GUI 400 used to visualize potential optimizations in a hierarchical organization, according to one embodiment disclosed herein. In the illustrated embodiment, the GUI 400 depicts a hierarchical organizational chart, indicating relationships between units of the organization. Specifically, a number of Nodes 405A-L indicate the individual data elements and/or logical units at various Levels 420A-C, and each Node 405 is associated with a corresponding Optimization Opportunity 410A-L.

In the illustrated GUI 400, each Node 405 is arranged to illustrate the hierarchy of the organization. For example, the top-level node corresponds to “General Facility Department,” which includes three sub-nodes: “General Medical Acute Care Unit,” “General Surgical Acute Care Unit,” and “Medical/Surgical Acute Care Unit.” In some embodiments, the user can select individual nodes in order to view more detail relating to that node and/or the nodes below it. For example, in the illustrated embodiment, the user has selected the “General Surgical Acute Care Unit” Node 405C, which has an estimated Optimization Opportunity 410C of $67,116, to view additional information.

Responsive to this selection, the Nodes 405E-L in the Level 420C have been displayed. Note that the data elements included under the other Nodes 405B and 405D in the Level 420B are not visible, in the depicted GUI 400 (e.g., because they were collapsed or hidden when the user selected the Node 405C). As illustrated, the relevant data elements for the General Surgical Acute Care Unit are the Area Wage Index (Node 405E), the requirement to have 80% or more full-time employees (which may be a law, policy, or regulation, and is indicated in Node 405F), the ratio between contract hours paid as a percentage of total hours paid (Node 405G), the percentage of management (Node 405H), the mandatory staff ratios (Node 4051), the percentage of overtime hours worked as a percentage of total hours worked (Node 405J), the hours paid per equivalent patient day (Node 405K), and the observation days as a percentage of the equivalent days (Node 405L).

In the illustrated embodiment, the optimization system has labeled each Node 405E-L with a corresponding Optimization Opportunity 410E-L, labeled as an “opportunity” if it represents a cost-saving opportunity, and an “impact” if it represents a non-actionable node, and/or a node representing a data element that, if changed, would cost more than the current structure. In some embodiments, as illustrated, the optimization system highlights or otherwise emphasizes the Nodes 405G and 405H where there are opportunities for cost reduction. Further, as illustrated, in determining a quantified Optimization Opportunity 410C for the higher-level Node 405C, the optimization system sums only the values that are positive and actionable, and does not include elements that cannot be changed, or where change would be less efficient.

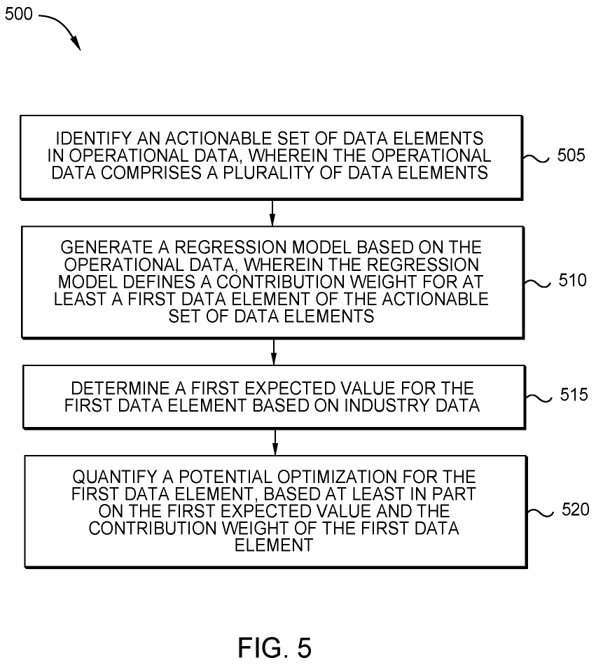

FIG. 5 is a flow diagram illustrating a method 500 to perform regression analysis on data elements to quantify optimizations, according to one embodiment disclosed herein. The method 500 begins at block 505, where an optimization system identifies an actionable set of data elements in operational data, wherein the operational data comprises a plurality of data elements. At block 510, the optimization system generates a regression model based the operational data, wherein the regression model defines a contribution weight for at least a first data element of the actionable set of data elements. The method 500 then continues to bock 515, where the optimization system determines a first expected value for the first data element based on industry data. Additionally, at block 520, the optimization system quantifies a potential optimization for the first data element, based at least in part on the first expected value and the contribution weight of the first data element.

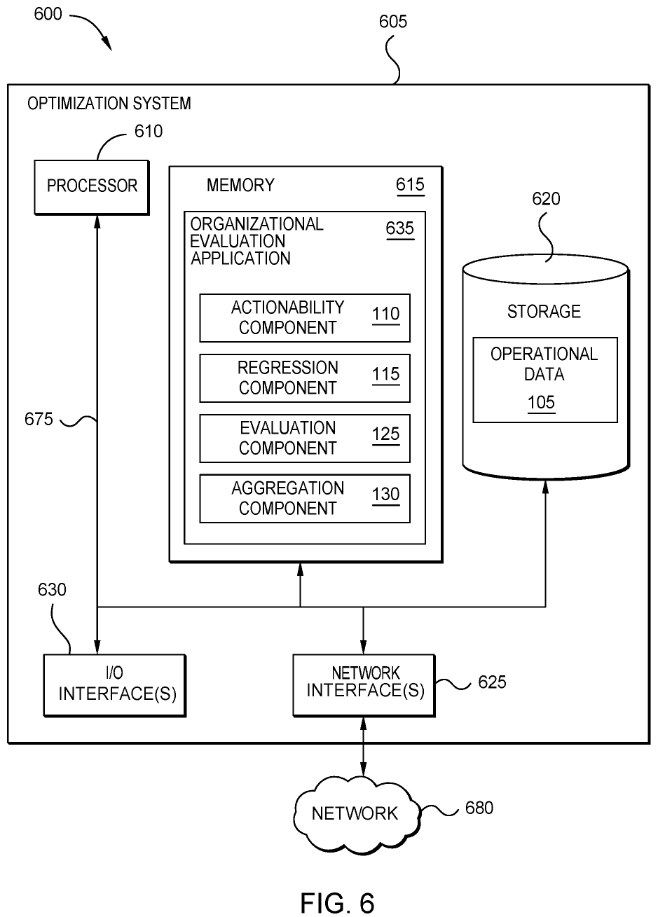

FIG. 6 is a block diagram depicting an Optimization System 605 configured to apply regression analysis to quantify optimizations, according to one embodiment disclosed herein. Although depicted as a physical device, in embodiments, the Optimization System 605 may implemented as a virtual device or service, and/or across a number of devices (e.g., in a cloud environment). As illustrated, the Optimization System 605 includes a Processor 610, Memory 615, Storage 620, a Network Interface 625, and one or more I/O Interfaces 630. In the illustrated embodiment, the Processor 610 retrieves and executes programming instructions stored in Memory 615, as well as stores and retrieves application data residing in Storage 620. The Processor 610 is generally representative of a single CPU and/or GPU, multiple CPUs and/or GPUs, a single CPU and/or GPU having multiple processing cores, and the like. The Memory 615 is generally included to be representative of a random access memory. Storage 620 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output devices (such as keyboards, monitors, etc.) are connected via the I/O Interface(s) 630. Further, via the Network Interface 625, the Optimization System 605 can be communicatively coupled with one or more other devices and components (e.g., via the Network 680, which may include the Internet, local network(s), and the like). Additionally, the Network 680 may include wired connections, wireless connections, or a combination of wired and wireless connections. As illustrated, the Processor 610, Memory 615, Storage 620, Network Interface(s) 625, and I/O Interface(s) 630 are communicatively coupled by one or more Buses 675.

In the illustrated embodiment, the Storage 620 includes Operational Data 105 for one or more entities. Although depicted as residing in Storage 620, in embodiments, the Operational Data 105 can reside in any suitable location. As discussed above, the Operational Data 105 generally includes data relating to the operations and structure of one or more organizations or entities, such as hospitals, businesses, corporations, and the like. The Operational Data 105 includes data elements specifying values for various metrics and measures that are relevant to the organization.

As illustrated, the Memory 615 includes an Organizational Evaluation Application 635. The Organizational Evaluation Application 635 is generally configured to evaluate actionability and optimization opportunities, using the techniques described in the present disclosure. For example, the Organizational Evaluation Application 635 can identify data elements that are actionable, determine a contribution ratio of each, and quantify cost-saving opportunities for each. Although depicted as software residing in Memory 615, in embodiments, the functionality of the Organizational Evaluation Application 635 can be implemented using hardware, software, or a combination of hardware and software. In the illustrated embodiment, the Organizational Evaluation Application 635 includes an Actionability Component 110, a Regression Component 115, an Evaluation Component 125, and an Aggregation Component 130. Although depicted as discrete components for conceptual clarity, in embodiments, the operations of the Actionability Component 110, Regression Component 115, Evaluation Component 125, and Aggregation Component 130 may be combined or distributed across any number of components.

In embodiments, the Actionability Component 110 evaluates data elements to determine whether each is actionable. This can include analysis of other documents and literature, review of the Operational Data 105, input from one or more users, and the like. The Regression Component 115 generally performs regression analysis on the Operational Data 105 to determine a contribution weight for each data element, relative to a specified goal or target (such as cost reduction). The Evaluation Component 125 generally computes and quantifies opportunities, based on the actionability data and contribution weights. Finally, the Aggregation Component 130 aggregates the data based on a defined organizational hierarchy. The resulting can then be output for user review.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding and/or following, reference is made to embodiments presented in this disclosure. However, the scope of the present disclosure is not limited to specific described embodiments. Instead, any combination of the preceding and/or following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding and/or following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the Organizational Evaluation Application 635) or related data available in the cloud. For example, the Organizational Evaluation Application 635 could execute on a computing system in the cloud and evaluate Operational Data 105. In such a case, the Organizational Evaluation Application 635 could quantify cost-saving opportunities, and store the results of the regression, evaluation, and classifications at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method, comprising:
identifying an actionable set of data elements in operational data, wherein the operational data comprises a plurality of data elements;
generating a regression model based on the operational data, wherein the regression model defines a contribution weight for at least a first data element of the actionable set of data elements;
determining a first expected value for the first data element based on industry data; and
quantifying a potential optimization for the first data element, based at least in part on the first expected value and the contribution weight of the first data element.

2. The method of claim 1, wherein each of the plurality of data elements comprises data relating to an operational aspect of an entity, wherein the plurality of data elements comprises one or more of:
(i) a data element corresponding to a number of employees employed by the entity;
(ii) a data element corresponding to a number of hours worked by employees employed by the entity; or
(iii) a data element corresponding to units of consumables used by the entity.

3. The method of claim 1, wherein determining the first expected value comprises evaluating operational data for a plurality of entities to determine a representative value for the first data element.

4. The method of claim 1, wherein determining the first expected value comprises applying matrix factorization to the industry data.

5. The method of claim 1, wherein identifying the actionable set of data elements comprises, for each respective data element of the plurality of data elements:
identifying a respective operational aspect corresponding to the respective data element; and
evaluating a corpus of documents to determine whether the respective operational aspect can be modified.

6. The method of claim 1, wherein quantifying the potential optimization for the first data element comprises multiplying the contribution weight of the first data element by a difference between the first expected value and a first actual value of the first data element.

7. The method of claim 1, wherein the operational data comprises hierarchical data for an entity, the method further comprising determining an overall optimization magnitude for the entity by iteratively summing potential optimizations for each level of the hierarchical data.

8. A computer program product comprising one or more computer-readable storage media collectively containing computer-readable program code that, when executed by operation of one or more computer processors, performs an operation comprising:
identifying an actionable set of data elements in operational data, wherein the operational data comprises a plurality of data elements;
generating a regression model based on the operational data, wherein the regression model defines a contribution weight for at least a first data element of the actionable set of data elements;
determining a first expected value for the first data element based on industry data; and
quantifying a potential optimization for the first data element, based at least in part on the first expected value and the contribution weight of the first data element.

9. The computer program product of claim 8, wherein each of the plurality of data elements comprises data relating to an operational aspect of an entity, wherein the plurality of data elements comprises one or more of:
(i) a data element corresponding to a number of employees employed by the entity;
(ii) a data element corresponding to a number of hours worked by employees employed by the entity; or
(iii) a data element corresponding to units of consumables used by the entity.

10. The computer program product of claim 8, wherein determining the first expected value comprises evaluating operational data for a plurality of entities to determine a representative value for the first data element.

11. The computer program product of claim 8, wherein determining the first expected value comprises applying matrix factorization to the industry data.

12. The computer program product of claim 8, wherein identifying the actionable set of data elements comprises, for each respective data element of the plurality of data elements:
identifying a respective operational aspect corresponding to the respective data element; and
evaluating a corpus of documents to determine whether the respective operational aspect can be modified.

13. The computer program product of claim 8, wherein quantifying the potential optimization for the first data element comprises multiplying the contribution weight of the first data element by a difference between the first expected value and a first actual value of the first data element.

14. The computer program product of claim 8, wherein the operational data comprises hierarchical data for an entity, the operation further comprising determining an overall optimization magnitude for the entity by iteratively summing potential optimizations for each level of the hierarchical data.

15. A system comprising:
one or more computer processors; and
one or more memories collectively containing one or more programs which when executed by the one or more computer processors performs an operation, the operation comprising:
identifying an actionable set of data elements in operational data, wherein the operational data comprises a plurality of data elements;
generating a regression model based on the operational data, wherein the regression model defines a contribution weight for at least a first data element of the actionable set of data elements;
determining a first expected value for the first data element based on industry data; and
quantifying a potential optimization for the first data element, based at least in part on the first expected value and the contribution weight of the first data element.

16. The system of claim 15, wherein each of the plurality of data elements comprises data relating to an operational aspect of an entity, wherein the plurality of data elements comprises one or more of:
(i) a data element corresponding to a number of employees employed by the entity;
(ii) a data element corresponding to a number of hours worked by employees employed by the entity; or
(iii) a data element corresponding to units of consumables used by the entity.

17. The system of claim 15, wherein determining the first expected value comprises evaluating operational data for a plurality of entities to determine a representative value for the first data element.

18. The system of claim 15, wherein determining the first expected value comprises applying matrix factorization to the industry data.

19. The system of claim 15, wherein identifying the actionable set of data elements comprises, for each respective data element of the plurality of data elements:
identifying a respective operational aspect corresponding to the respective data element; and
evaluating a corpus of documents to determine whether the respective operational aspect can be modified.

20. The system of claim 15, wherein quantifying the potential optimization for the first data element comprises multiplying the contribution weight of the first data element by a difference between the first expected value and a first actual value of the first data element.
